(19) United States
(12) Patent Application Publication
(10) Pub. No.: US 2019/0286264 A1
(43) Pub. Date: Sep. 19, 2019

(54) TOUCH PANEL AND TOUCH DISPLAY DEVICE

(71) Applicant: KunShan Go-Visionox Opto-Electronics Co., Ltd., Kunshan (CN)

(72) Inventors: Weiguo LI, Kunshan (CN); Guizhou QIAO, Kunshan (CN); Zhihua ZHANG, Kunshan (CN); Shengzu ZHU, Kunshan (CN); Jianping CHEN, Kunshan (CN)

(73) Assignee: KunShan Go-Visionox Opto-Electronics Co., Ltd., Kunshan (CN)

(21) Appl. No.: 16/433,411

(22) Filed: Jun. 6, 2019

Related U.S. Application Data
(63) Continuation of application No. PCT/CN2018/097348, filed on Jul. 27, 2018.

(30) Foreign Application Priority Data
Dec. 29, 2017 (CN) 201711485055.6

(51) Int. Cl. G06F 3/044; G06K 9/00

(52) U.S. Cl. CPC G06F 3/044; G06F 2203/04111; G06K 9/00013

(57) ABSTRACT

The disclosure relates to the field of touch technology, and in particular to a touch panel and a touch display device. A touch panel includes a touch film layer and a fingerprint recognition film layer. A touch film layer is provided with at least one predetermined hollow region, an orthographic project of the fingerprint recognition film layer on the touch film layer is located in at least one predetermined hollow region of the touch film layer.

### CROSS-REFERENCE TO RELATED APPLICATION

This disclosure claims the priority of Chinese Patent Application No. 201711485055.6 filed on Dec. 29, 2017, entitled “TOUCH PANEL AND TOUCH DISPLAY DEVICE”, the entire contents of which are hereby incorporated by reference.

### TECHNICAL FIELD

The disclosure relates to the field of touch technology, and particularly to a touch panel and a touch display device.

### BACKGROUND

Currently, in the display panel with a fingerprint recognition function, a fingerprint recognition module is generally arranged in a non-display area of the display panel, and is mostly arranged at the position corresponding to an exposed Home key. The fingerprint information of the user can be collected when the user touches the Home key with his/her finger. And then the fingerprint recognition is completed based on the comparison result.

However, arranging the fingerprint recognition module in the non-display area will inevitably limit the full screen design of the display panel and is disadvantageous to realize the full screen of the display panel.

Therefore, there is an urgent need to find a full screen solution realizing fingerprint recognition.

### SUMMARY

Embodiments of the disclosure provide a touch panel and a touch display device to overcome the above technical problem.

In order to overcome the above technical problem, an embodiment of the disclosure can adopt the following technical solution: a touch panel, including a touch film layer and a fingerprint recognition film layer; wherein an orthographic project of the fingerprint recognition film layer on the touch film layer is located in at least one predetermined hollow region of the touch film layer.

Optionally, the touch film layer comprises a plurality of touch driving electrodes extending along a first direction, a plurality of touch sensing electrodes extending along a second direction, and the hollow region is formed by making the touch driving electrode be insulated from and intersected with the touch sensing electrode; the fingerprint recognition film layer comprises a plurality of fingerprint recognition patterns arranged in the hollow region, each fingerprint recognition pattern comprises a plurality of fingerprint driving electrodes extending along a third direction, a plurality of fingerprint sensing electrodes extending along a fourth direction, and the fingerprint driving electrode is insulated from and intersected with the fingerprint sensing electrode.

Optionally, the touch driving electrode and the touch sensing electrode are located in different film layers, and are separated by a transparent insulation layer.

Optionally, the transparent insulation layer is arranged only at the position where the touch driving electrode is intersected with the touch sensing electrode.

Optionally, in the fingerprint recognition film layer, leads of each row of fingerprint driving electrodes are correspondingly connected to different first pins, and leads of each column of fingerprint sensing electrodes are correspondingly connected to different second pins.

Optionally, in every fingerprint recognition pattern, the leads of each row of fingerprint driving electrodes are correspondingly connected to different first pins, and the leads of each column of fingerprint sensing electrodes are correspondingly connected to different second pins; in different fingerprint recognition patterns, each row of fingerprint driving electrodes is commonly connected to the same first pin, each column of fingerprint sensing electrodes is commonly connected to the same second pin.

Optionally, the touch driving electrode and/or the touch sensing electrode are touch electrodes with a first hollow pattern; a second hollow pattern is formed by making the fingerprint driving electrode be intersected with the fingerprint sensing electrode and is the same with the first hollow pattern.

Optionally, the fingerprint recognition film layer is arranged on any side of the touch film layer, or is sandwiched between the film layer at which the touch driving electrode is located and the film layer at which the touch, sensing electrode is located in the touch film layer.

Optionally, the touch panel further comprises: a display film layer comprising a plurality of light-emitting sub-pixels arranged in an array; in the fingerprint recognition pattern, an orthographic projection of each fingerprint driving electrode and/or each fingerprint sensing electrode on the touch film layer is not in coincidence with an orthographic projection of the light-emitting sub-pixels in the display film layer on the touch film layer.

Optionally, a material for the fingerprint recognition pattern is a transparent conductive material or a metal material.

Optionally, in the touch film layer, a central-to-central distance between the adjacent touch driving electrodes ranges from 3 to 7 mm, and a central-to-central distance between the adjacent touch sensing electrodes ranges from 3 to 7 mm; in the fingerprint recognition film layer, the central-to-central distance between the adjacent fingerprint recognition patterns ranges from 3 to 7 mm.

A touch display device includes the above touch panel.

The following beneficial effects can be achieved by the above-mentioned at least one technical solution adopted by the embodiments of the disclosure: with the technical solution, fingerprint recognition patterns are arranged at all hollow regions formed by the touch driving electrodes and the touch sensing electrodes of the entire touch film layer, so that the fingerprint recognition patterns are distributed over the entire surface of the touch film layer. The fingerprint recognition can be achieved by the fingerprint recognition pattern by means of the capacitance formed by the fingerprint driving electrode and the fingerprint sensing electrode at the intersecting position, thereby avoiding the problem of interference caused by the capacitance between the touch film layer and the fingerprint recognition film layer. The fingerprint recognition can be achieved in each area of the touch panel, avoiding the fingerprint recognition limitation caused by the arrangement of the fingerprint recognition module only in a non-display area of the panel in the prior art. Moreover, the solution is favorable for realizing the full screen of the panel and improving the touch of the touch panel and fingerprint recognition quality of the touch panel.

### BRIEF DESCRIPTION OF THE DRAWINGS

In the drawings:

FIG. 1 is a first schematic structural view of a touch panel provided by an embodiment of the disclosure;

FIG. 2(a) to FIG. 2(b) are schematic views of an electrode extending direction of a fingerprint recognition pattern in a touch panel provided by an embodiment of the disclosure;

FIG. 3(a)-3(c) are schematic views of three partial structures of a touch panel provided by the disclosure;

FIG. 4 is a second schematic structural view of a touch panel provided by the disclosure; and

FIG. 5 is a schematic cross-sectional structural view of a touch panel provided by the disclosure.

### DETAILED DESCRIPTION OF PREFERRED EMBODIMENTS

In order to make the purposes, technical solutions and advantages of the disclosure clearer, the technical solutions of the disclosure will be clearly and completely described below with reference to the specific embodiments and the corresponding drawings.

The technical solutions provided by the embodiments of the disclosure are described in detail below with reference to the accompanying drawings.

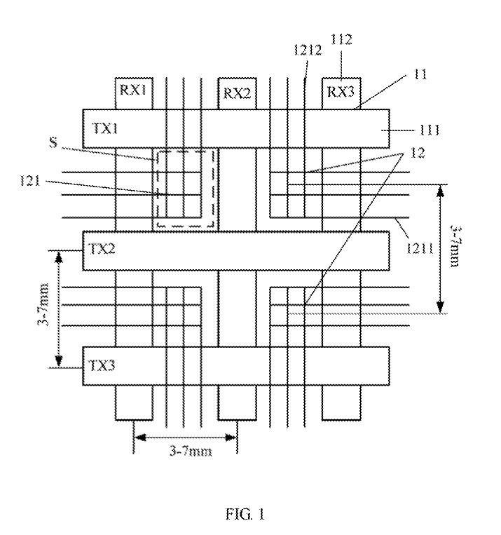

With reference to FIG. 1. FIG. 1 is a schematic structural view of a touch panel provided by an embodiment of the disclosure. The touch panel mainly includes: a touch film layer 11 and a fingerprint recognition film layer 12. An orthographic projection of the fingerprint recognition film layer 12 on the touch film layer 11 is located in at least one predetermined hollow region of the touch film layer 11.

The fingerprint recognition film layer 12 may be arranged on the touch film layer 11, and may also be arranged on other film layers, and may also be arranged on any side of the touch film layer 11. The film layer position relationship of the fingerprint recognition film layer 12 is not limited in the disclosure.

In the touch film layer 11 and the fingerprint recognition film layer 12 arranged on the touch film layer 11, the touch film layer 11 includes a plurality of touch driving electrodes 111 extending along a first direction and a plurality of touch sensing electrodes 112 extending along a second direction; the touch driving electrode 111 is configured to be insulated from the touch sensing electrode 112, and the touch driving electrode 111 is intersected with the touch sensing electrode 112 to define a plurality of hollow regions S (the area indicated by a dashed frame in FIG. 1); the touch driving electrode 11 may be preferable to illustrate by taking the setting in different layers insulated from each other as an example, and is not limited to the setting in the same layer either.

The fingerprint recognition film layer 12 includes a plurality of fingerprint recognition patterns 121 which are arranged in the hollow region S. Each fingerprint recognition pattern 121 includes a plurality of fingerprint driving electrodes 1211 extending in a third direction and a plurality of fingerprint sensing electrodes 1212 extending in a fourth direction. The fingerprint driving electrode 1211 is insulated from and intersected with the fingerprint sensing electrode 1212.

Optionally, the touch driving electrode 111 and the touch sensing electrode 112 are located in different film layers, and are separated by a transparent insulation layer. Optionally, the transparent insulation layer may be arranged only at the intersecting position of the touch driving electrode 111 and the touch sensing electrode 112, and does not need to be spread throughout the entire touch film layer. The wiring of the fingerprint driving electrode 1211 and the fingerprint sensing electrode 1212 are relatively dense, and the density of the formed hollow pattern (for example, a grid) is large. Moreover, the line widths of the fingerprint driving electrode 1211 and the fingerprint sensing electrode 1212 each are less than 5 μm, thereby adapting to a ridge rib of a user's fingerprint (i.e., concave and convex lines of the fingerprint) to collect more accurate fingerprint information. The fingerprint driving electrode 1211 and the fingerprint sensing electrode 1212 may be provided with a transparent insulative material at the intersecting position. The fingerprint driving electrode 1211 and the fingerprint sensing electrode 1212 may be arranged in the same layer or in different layers, which is not limited thereto in the disclosure.

In the structure shown in FIG. 1, the touch driving electrode 111 and the touch sensing electrode 112 in the touch film layer 11 may be transparent strip electrodes to avoid blocking light.

With the technical solution, fingerprint recognition patterns are arranged at all hollow regions formed by the touch driving electrodes and the touch sensing electrodes of the entire touch film layer, so that the fingerprint recognition patterns are distributed over the entire surface of the touch film layer. The fingerprint recognition can be achieved by the fingerprint recognition pattern by means of the capacitance formed by the fingerprint driving electrode and the fingerprint sensing electrode at the intersecting position, thereby achieving fingerprint recognition in each area of the touch panel and avoiding the fingerprint recognition limitation caused by the arrangement of the fingerprint recognition module only in a non-display area of the panel. The solution is favorable for realizing the full screen of the panel and improving the touch of the touch panel and fingerprint recognition quality of the touch panel.

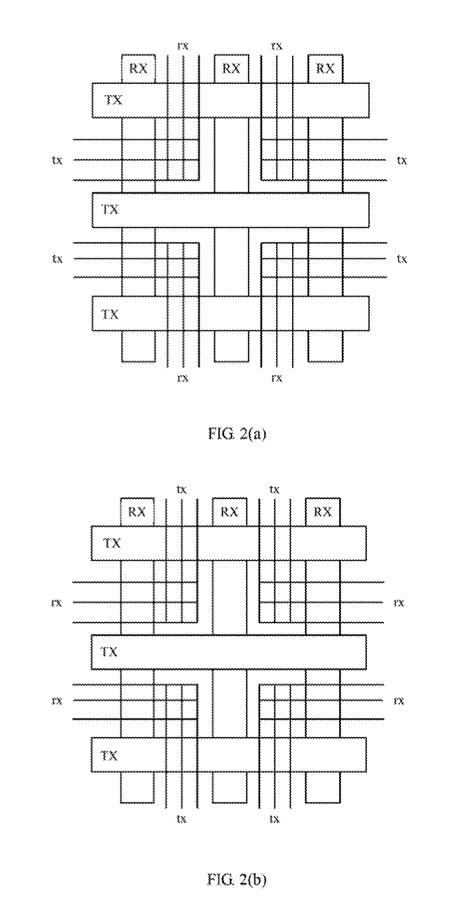

Optionally, in the disclosure, with reference to FIG. 2(a), a touch driving electrode TX is disposed and extended along a first direction, a fingerprint driving electrode tx is disposed and extended along a third direction, and the first direction is the same with the third direction. Similarly, a touch sensing electrode RX is disposed and extended along a second direction, a fingerprint sensing electrode rx is disposed and extended along a fourth direction, and the second direction is the same with the fourth direction.

Alternatively, as shown in FIG. 2(b), the touch driving electrode TX is disposed and extended along the first direction, the fingerprint sensing electrode rx is disposed and extended along the fourth direction, and the first direction is the same with the fourth direction. The touch sensing electrode RX is disposed and extended along the second direction, the fingerprint driving electrode tx is disposed and extended along the third direction, and the second direction is the same with the third direction.

Optionally, in the disclosure, connection manners of leads of the touch driving electrodes and the touch sensing electrodes are not limited, and generally, each lead is connected to a different pin, so that a touch location is determined by the change in capacitance at intersecting positions of the different leads. The connection structure between the lead of the fingerprint driving electrode and the lead of the fingerprint sensing electrode can be designed according to the actual screen body of the touch panel, and there are the following connection structures:

Connection structure 1: in the fingerprint recognition film layer, the leads of fingerprint driving electrodes of each row are correspondingly connected to different first pins, and the leads of fingerprint sensing electrodes of each column are correspondingly connected to different second pins.

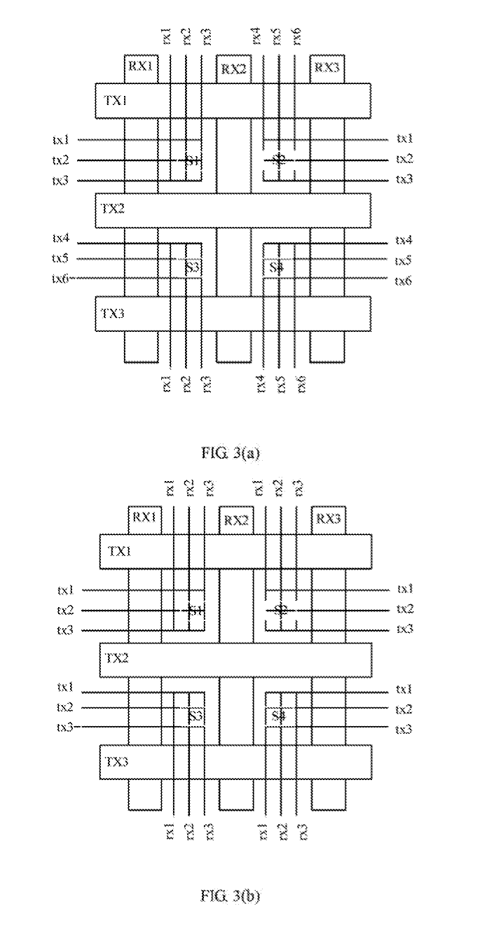

Specifically with reference to FIG. 3(a), FIG. 3(a) is a partial structural view of a touch panel provided by the disclosure, the FIG. 3(a) only shows: the touch driving electrodes TX1 to TX3, each touch driving electrode extends along the lateral direction, and the touch driving electrodes TX1 to TX3 are arranged in three rows; the touch sensing electrodes RX1 to RX3, each touch sensing electrode extends along the longitudinal direction, and the touch sensing electrodes RX1 to RX3 are arranged in three columns. In the touch panel, the size of the electrode in the touch driving electrode and the touch sensing electrode may be not limited, and the material thereof is a transparent conductive material to avoid blocking and ensure display quality.

In the hollow regions defined and formed by mutual intersection of the touch driving electrode TX1 the touch driving electrode TX2, the touch driving electrode TX3, the touch sensing electrode RX1, the touch sensing electrode RX2, and the touch sensing electrode RX3, taking the hollow region S1 at the upper left corner as an example, three fingerprint driving electrodes tx1 to tx3 extending laterally and three fingerprint sensing electrodes rx1 to rx3 extending longitudinally are arranged to form a fingerprint recognition pattern 1. Similarly, taking the hollow region S2 at the upper right corner as an example, three fingerprint driving electrodes tx1 to tx3 extending laterally and three fingerprint sensing electrodes rx4 to rx6 extending longitudinally are arranged to form a fingerprint recognition pattern 2. Similarly, taking the hollow region S3 at the lower left corner as an example, three fingerprint driving electrodes tx4 to tx6 extending laterally and three fingerprint sensing electrodes rx1 to rx3 extending longitudinally are arranged to form a fingerprint recognition pattern 3. Similarly, taking the hollow region S4 at the lower right corner as an example, three fingerprint driving electrodes tx4 to tx6 extending laterally and three fingerprint sensing electrodes rx4 to rx6 extending longitudinally are arranged to form a fingerprint recognition pattern 4. The fingerprint driving electrodes tx1 to tx6 represent fingerprint driving electrodes connected to the same type of pins (for example, the first pins), and the different markers indicate that they are connected to different first pins. The fingerprint driving electrodes rx1 to rx6 represent fingerprint driving electrodes connected to the same type of pins (for example, the second pins), and the different markers indicate that they are connected to different second pins.

Therefore, the leads of the fingerprint driving electrodes of each row are correspondingly connected to different first pins, and the leads of the fingerprint sensing electrodes of each column are correspondingly connected to different second pins, so that the fingerprint recognition patterns can be used in conjunction with each other. When the fingerprint area is large or the central distance between the adjacent hollow region is small, a plurality of fingerprint recognition patterns are simultaneously used and cooperated with each other to collect the same fingerprint and then to combine into the corresponding fingerprint information. The structural design of the touch panel can be applied to the case where the fingerprint recognition pattern is dense, and the fingerprint recognition sensitivity of the structural design is higher.

Connection structure 2: In every the fingerprint recognition pattern, the leads of fingerprint driving electrodes of each row are correspondingly connected to different first pins, and the leads of fingerprint sensing electrodes of each column are correspondingly connected to different second pins. In different fingerprint recognition patterns, the fingerprint driving electrodes in the same row are commonly connected to the same first pin, the fingerprint sensing electrodes in the same column are commonly connected to the same second pin.

Specifically with reference to FIG. 3(b), FIG. 3(b) is a partial structural view of a touch panel provided by the disclosure, the structure of FIG. 3(b) is similar to the structure of FIG. 3(a), which is not described in detail herein.

In the hollow regions defined and formed by mutual intersection of the touch driving electrode TX1, the touch driving electrode TX2, the touch driving electrode TX3, the touch sensing electrode RX1, the touch sensing electrode RX2, and the touch sensing electrode RX3, taking the hollow region S1 at the upper left corner as an example, three fingerprint driving electrodes tx1 to tx3 extending laterally and three fingerprint sensing electrodes rx1 to rx3 extending longitudinally are arranged to form a fingerprint recognition pattern 1. Similarly, three fingerprint driving electrodes tx1 to tx3 extending laterally and three fingerprint sensing electrodes rx1 to rx3 extending longitudinally are arranged in the hollow region S2 at the upper right corner to form a fingerprint recognition pattern 2. Similarly, three fingerprint driving electrodes tx1 to tx3 extending laterally and three fingerprint sensing electrodes rx1 to rx3 extending longitudinally are arranged in the hollow region S3 at the lower left corner to form a fingerprint recognition pattern 3. Three fingerprint driving electrodes tx1 to tx3 extending laterally and three fingerprint sensing electrodes rx1 to rx3 extending longitudinally are arranged in the hollow region S4 at the lower right corner to form a fingerprint recognition pattern 4. Wherein, the fingerprint driving electrodes tx1 to tx3 represent fingerprint driving electrodes connected to the same type of pins (for example, the first pins), and the different markers indicate that they are connected to different first pins. The fingerprint driving electrodes rx1 to rx3 represent fingerprint driving electrodes connected to the same type of pins (for example, the second pins), and the different markers indicate that they are connected to different second pins.

Therefore, each fingerprint recognition pattern can be regarded as the same. Among the plurality of fingerprint driving electrodes, the fingerprint driving electrodes with the same marker are correspondingly connected to the same first pin; among the plurality of fingerprint sensing electrodes, the fingerprint sensing electrodes with the same marker are correspondingly connected to the same second pin. In this way, the setting number of the pins can be reduced and the design structure can be simplified. Moreover, each fingerprint recognition pattern can be used as an independent fingerprint recognition area for fingerprint recognition, thereby improving the design flexibility of the touch structure.

Optionally, in the disclosure, the line widths of the fingerprint driving electrodes and the fingerprint sensing electrodes arranged in each hollow region are relatively thin, and the leads of the fingerprint driving electrodes and the fingerprint sensing electrodes are correspondingly thinner, or basically the same as the line widths of the fingerprint driving electrodes and the fingerprint sensing electrodes. Taking the structure of the touch panel shown in FIG. 3(c) as an example, the fingerprint driving electrode tx1 in the hollow region S1 is connected to the fingerprint driving electrode tx1 in the hollow region S2, and connected to the corresponding first pins through the leads of the fingerprint driving electrode tx1 located on either edge side. Similarly, other fingerprint driving electrodes or fingerprint sensing electrodes with the same marker are also connected to each other in a similar manner and connected to the corresponding first pins through one lead, thereby avoiding the problem of a larger wiring space caused by excessive drawn leads and increased wiring complexity caused by more wirings and simplifying the structure of the touch panel.

Optionally, the touch driving electrode and/or the touch sensing electrode is a touch electrode with a first hollow pattern, and a second hollow pattern is formed by making the fingerprint driving electrode be intersected with the fingerprint sensing electrode and the second hollow pattern is the same with the first hollow pattern.

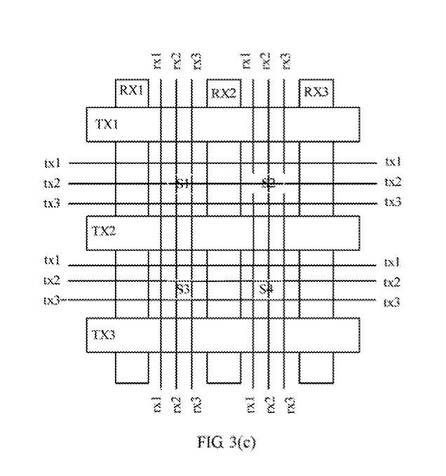

Specifically with reference to FIG. 4, FIG. 4 is illustrated by taking both the touch driving electrode 111 and the touch sensing electrode 112 being metal grid electrodes. Optionally, the first hollow pattern may also be other graphs, and is not limited to a grid. Then, the second hollow pattern formed by making the fingerprint driving electrode 1211 be intersected with the fingerprint sensing electrode 1212 may also be a grid pattern, and the size of the metal grid in the touch driving electrode 111 and the touch sensing electrode 112 may be the same as the size of the grid formed by making the fingerprint driving electrode 1211 be intersected with the fingerprint sensing electrode 1212. Therefore, the grid patterns can be evenly arranged in the touch panel to ensure the accuracy of fingerprint recognition and improve the accuracy of the touch.

Optionally, in the disclosure, the fingerprint recognition film layer is arranged on any surface of the touch film layer, or is sandwiched between the film layer at which the touch driving electrode is located and the film layer at which the touch sensing electrode is located in the touch film layer.

Specifically, if the touch driving electrode TX extending laterally is located above the touch sensing electrode RX extending longitudinally, the fingerprint recognition film layer may be arranged above the touch driving electrode TX or arranged below the touch sensing electrode RX, or sandwiched between the touch driving electrode TX and the touch sensing electrode RX.

Optionally, in the disclosure, the touch panel further includes: a display film layer including a plurality of light-emitting sub-pixels arranged in an array; in the fingerprint recognition pattern, an orthographic projection of each fingerprint driving electrode and/or each fingerprint sensing electrode on the touch film layer is not in coincidence with an orthographic projection of the light-emitting sub-pixels in the display film layer on the touch film layer.

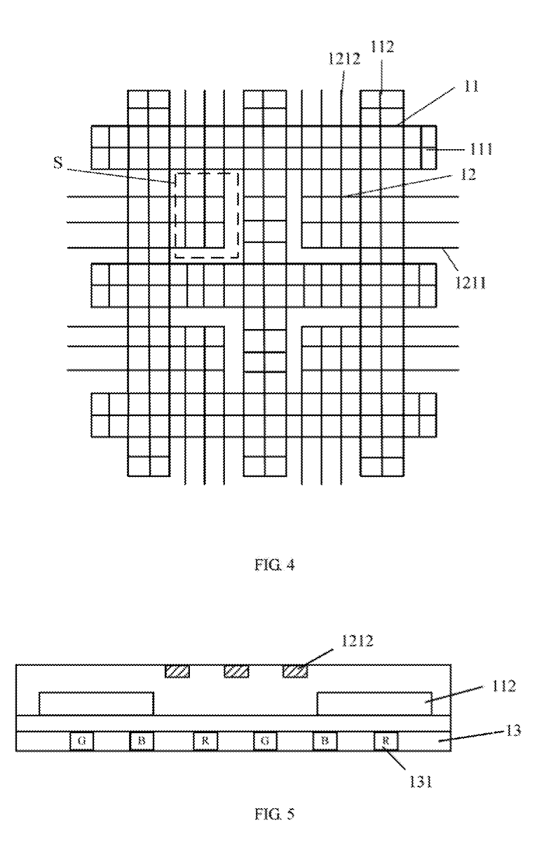

Specifically, with reference to FIG. 5, FIG. 5 is a cross-sectional schematic structural view taken along the line a-a of FIG. 3(c), taking the display film layer 13 located below the touch film layer 11 and the fingerprint recognition film layer 12 located above the touch film layer 11 as an example, the display film layer 13 includes an light-emitting sub-pixel 131. In the fingerprint recognition pattern, an orthographic projection of the fingerprint sensing electrode 1212 on the touch film layer is not in coincidence with an orthographic projection of the light-emitting sub-pixel 131 in the display film layer 13 on the touch film layer. Therefore, the fingerprint recognition pattern can reasonably avoid the light-emitting sub-pixels and avoid blocking the light-emitting sub-pixels, thereby ensuring a superior light-exiting efficiency and display quality. Wherein, an insulation layer is further arranged between the touch film layer and the display film layer, and an insulation layer is also arranged between the fingerprint recognition film layer and the touch film layer, the insulation layers are shown by blank.

Optionally, in the disclosure, a material for the fingerprint recognition pattern is a transparent conductive material or a metal material. Since the line width of the fingerprint recognition pattern is thin, the two materials involved in the disclosure can avoid the light-emitting sub-pixels and avoid blocking to a certain extent.

Optionally, in the touch film layer, the central-to-central distance between the adjacent touch driving electrodes ranges from 3 to 7 mm, and the central-to-central distance between the adjacent touch sensing electrodes ranges from 3 to 7 mm; in the fingerprint recognition film layer, the central-to-central distance between the adjacent fingerprint recognition patterns ranges from 3 to 7 mm.

Specifically, as shown in FIG. 1, the central-to-central distance between the touch driving electrode TX2 and the touch driving electrode TX3 ranges from 3 to 7 mm, the central-to-central distance between the touch sensing electrode RX1 and the touch sensing electrode RX2 ranges from 3 to 7 mm. The central-to-central distance between the fingerprint recognition pattern located in the hollow region S1 and the fingerprint recognition pattern located in the hollow region S2 ranges from 3 to 7 mm.

Optionally, in the disclosure, the above size range is not uniquely limited, and the size of the fingerprint recognition pattern in the fingerprint recognition film layer is related to the module structure of the touch panel, the thickness of the cover plate and the screen resolution.

It should be noted that the fingerprint recognition mode of the fingerprint recognition pattern involved in the disclosure is a kind of capacitive fingerprint recognition, and the fingerprint image is recognized and obtained by the influence of the ridge rib of the fingerprint on the capacitance between the fingerprint driving electrode and the fingerprint sensing electrode.

The disclosure also provides a touch display device including the touch panel according to any one of the above touch panels. In addition, the touch display device can be any products or components with the display function, such as a mobile phone, a tablet computer, a television, a display, a notebook computer, a digital photo frame, a navigator, a smart wearable device and the like. Other components possessed indispensable to the display device can be understood by a person skilled in the art, which are not described in detail herein, nor should be construed as a limitation to the disclosure.

What is claimed is:

1. A touch panel, comprising a touch film layer and a fingerprint recognition film layer; wherein the touch film layer is provided with at least one predetermined hollow region, an orthographic project of the fingerprint recognition film layer on the touch film layer is located in at least one predetermined hollow region of the touch film layer.

2. The touch panel according to claim 1, wherein the touch film layer comprises a plurality of touch driving electrodes extending along a first direction, a plurality of touch sensing electrodes extending along a second direction, and the hollow region is formed by making the touch driving electrode be insulated from and intersected with the touch sensing electrode;
the fingerprint recognition film layer comprises a plurality of fingerprint recognition patterns arranged in the hollow regions, each fingerprint recognition pattern comprises a plurality of fingerprint driving electrodes extending along a third direction, a plurality of fingerprint sensing electrodes extending along a fourth direction, and the fingerprint driving electrode is insulated from and intersected with the fingerprint sensing electrode.

3. The touch panel according to claim 2, wherein the touch driving electrode and the touch sensing electrode are located in different touch film layers, and are separated by a transparent insulation layer.

4. The touch panel according to claim 3, wherein the transparent insulation layer is arranged only at a intersection position between the touch driving electrode and the touch sensing electrode.

5. The touch panel according to claim 2, wherein in the fingerprint recognition film layer, leads of fingerprint driving electrodes of each row are correspondingly connected to different first pins, and leads of fingerprint sensing electrodes of each column are correspondingly connected to different second pins.

6. The touch panel according to claim 2 wherein in every fingerprint recognition pattern, the leads of fingerprint driving electrodes of each row are correspondingly connected to different first pins, and the leads of fingerprint sensing electrodes of each column are correspondingly connected to different second pins;
in different fingerprint recognition patterns, the fingerprint driving electrodes of each row are commonly connected to the same first pin, the fingerprint sensing electrodes of each column are commonly connected to the same second pin.

7. The touch panel according to claim 2, wherein the touch driving electrodes and/or the touch sensing electrodes are touch electrodes with a first hollow pattern;
a second hollow pattern is formed by making the fingerprint driving electrode be intersected with the fingerprint sensing electrode and the second hollow pattern is the same with the first hollow pattern.

8. The touch panel according to claim 2, wherein the fingerprint recognition film layer is arranged on either side of the touch film layer, or is sandwiched between the touch film layer at which the touch driving electrode is located and the touch film layer at which the touch sensing electrode is located in the touch film layer.

9. The touch panel according to claim 1, wherein the touch panel further comprises: a display film layer comprising a plurality of light-emitting sub-pixels arranged in an array;
in the fingerprint recognition pattern, an orthographic projection of each fingerprint driving electrode and/or each fingerprint sensing electrode on the touch film layer is not in coincidence with an orthographic projection of the light-emitting sub-pixels in the display film layer on the touch film layer.

10. The touch panel according to claim 9, wherein a material for the fingerprint recognition pattern is a transparent conductive material or a metal material.

11. The touch panel according to claim 2, wherein in the touch film layer, a central-to-central distance between the adjacent touch driving electrodes ranges from 3 to 7 mm, and a central-to-central distance between the adjacent touch sensing electrodes ranges from 3 to 7 mm;
in the fingerprint recognition film layer, the central-to-central distance between the adjacent fingerprint recognition patterns ranges from 3 to 7 mm.

12. A touch display device, wherein comprising the touch panel according to claim 1, the touch panel comprising a touch film layer and a fingerprint recognition film layer; wherein an orthographic project of the fingerprint recognition film layer on the touch film layer is located in at least one predetermined hollow region of the touch film layer.
